(19) United States
(12) Patent Application Publication
(10) Pub. No.: US 2008/0195676 A1
(43) Pub. Date: Aug. 14, 2008

(54) Scanning of backup data for malicious software

(75) Inventors: James Lyon, Redmond, WA (US); James Christopher Gray, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/706,103

(22) Filed: Feb. 14, 2007

(51) Int. Cl. G06F 12/16

(52) U.S. Cl. 707/204; 707/E17.044

(57) ABSTRACT

A backup system may create one or more archived copies of a file system, such as through successive periodic backup operations. When a virus or other malicious software is found on a system, that system's backup data is scanned to determine the last uninfected backup. A full or partial restore of the system may be performed using the last uninfected backup. In some cases, a malicious software scan may be performed by a second system on the backup data of a first system that has been infected. By using a second system, any malicious software on the first system may not be operating on the system that performs the malicious software scan.

### BACKGROUND

Backup systems are used to store archival copies of all or a portion of data storage systems. The archival or backup copies may be used to restore a corrupted file, an inadvertently deleted file, or restore an entire file system.

Many systems may perform backups at regular intervals. Some systems may perform complete backups, where the entire contents of a file system are duplicated, while other systems may perform incremental backups where only those data or files that have changed since the last backup are saved.

Malware is a term used to describe malicious software, such as computer viruses, worms, trojan horses, spyware, adware, and other malicious and unwanted software. Malware is sometimes known as a computer contaminant. Malware detectors are used to analyze operating or stored computer code to find malware. In some cases, the detectors operate by intercepting code that may be loaded into memory for execution, analyzing incoming code when receiving an email or other communication, or through periodic analysis of stored data on a data storage system.

### SUMMARY

A backup system may create one or more archived copies of a file system, such as through successive periodic backup operations. When a virus or other malicious software is found on a system, that system's backup data is scanned to determine the last uninfected backup. A full or partial restore of the system may be performed using the last uninfected backup. In some cases, a malicious software scan may be performed by a second system on the backup data of a first system that has been infected. By using a second system, any malicious software on the first system may not be operating on the system that performs the malicious software scan.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a pictorial illustration of an embodiment showing a system with a malicious software scanner for backup data.

FIG. 2 is a timeline illustration of an embodiment of a sequence of backing up, scanning, and restoring data.

FIG. 3 is a flowchart illustration of an embodiment of a method for handling infected files.

### DETAILED DESCRIPTION

When malicious software is detected in a client system, backup copies of the client system's data may be scanned to determine a clean version of a file or an entire file structure for the client system. The backup data may be scanned by a second system, one that may not be infected by malicious software. Since backup data may be scanned without having to load and execute data from a backup storage device, malicious software on the client system may not be able to infect the second system. In a typical application, the second system may be a server system that also performs backup services for a client system.

Many different methods may be used to backup a file system. In some embodiments, a file-based backup system may archive individual copies of files. A typical file-based backup system may make a complete copy of a file system and then perform incremental backups of changes to the file system over time.

In other embodiments, cluster-based backup systems may archive individual clusters of data from a client data storage device. In a typical cluster-based backup system, each cluster may be hashed and the resulting hash value may be compared to other hash values of stored clusters. If there is no corresponding hash value for a stored cluster, the cluster is archived.

When scanning client backup data, a latest version of an uninfected file or file system may be determined. A restore process may use the latest version to restore a client file system. In some instances, a single infected file may be restored, while in other cases all or a substantial portion of a file system may be restored.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

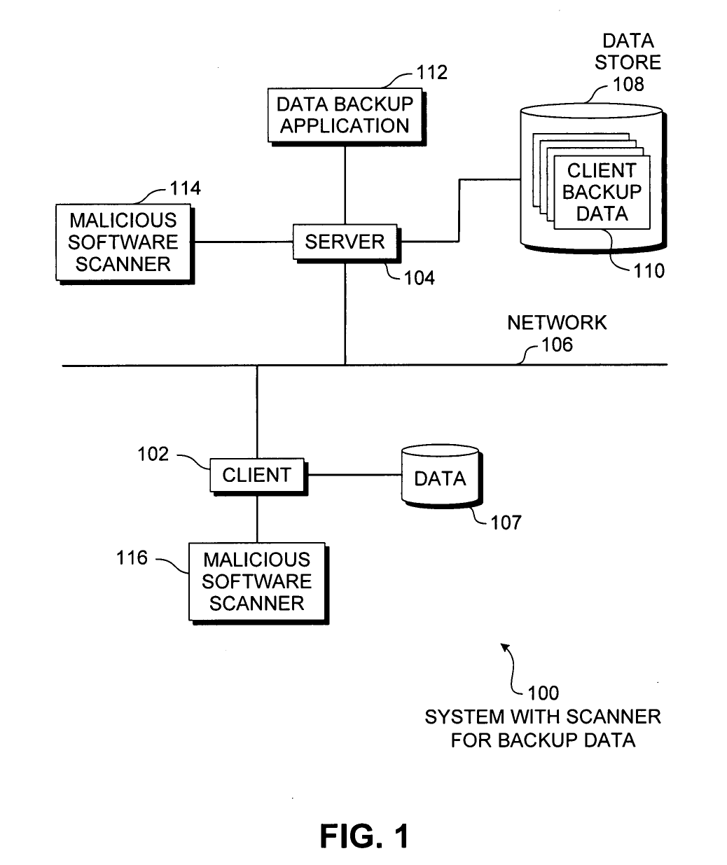

FIG. 1 is a diagram of an embodiment 100 showing a system with a malicious software scanner for backup data. A client device 102 is connected to a server 104 through the network 106. The client device 102 has a data storage system 107 that is backed up into a data store 108 attached to the server 104. The data store 108 may contain client backup data 110 that may include backup data from multiple backup operations. The server 104 may have a software application 112 for performing data backup. The server 104 may also have a malicious software scanner 114 that may be capable of performing scans on the client backup data 110. The client 102 may have a malicious software scanner 116 that may be capable of performing scans on the client data storage device 107.

Embodiment 100 has a client 102 and server 104, where the server 104 may store archive copies of data from the client data storage system 107. The data in the client data storage system 107 may be data stored in data files and may include executable software applications, data storage files, configuration files, operating system files, database files, or any type of computer-accessible data. The malicious software scanner 116 attached to client 102 may be set up to periodically scan the data storage system 107 as well as when incoming data or software installations are detected.

The client 102 may be any type of network compatible device that has an attached data storage system. For example, client 102 may be a personal computer attached to a network, but may also be a cellular telephone, personal digital assistant, network appliance, or other device that has a data storage system 107 that may be backed up periodically.

The server 104 may be a server computer on a network, but may also be a network storage appliance, a dedicated backup and archival system, a personal computer performing backup storage for anther device, or any other type of system or device that can store backup or archived data for another device.

When malicious software is detected on the client device 102, a scan of the backup data 110 may determine a latest version of a file or a portion or all of a file system. The latest version may be used to restore the client data system 107 to an uninfected state.

Malicious software may be determined in any manner. In some instances, the malicious software scanner 116 attached to the client 102 may detect that malicious software is operating on a processor within the client 102 or that malicious software exists within the client data storage system 107. In other instances, the malicious software scanner 114 attached to the server 104 may determine that data being archived from the client data storage 107 may be infected or that a periodic scan of the backup data 110 reveals one or more infected files. In still other instances, a third system such as a firewall, email system, or other system may determine that malicious software is present.

Once malicious software is detected on the client device 102, a scan of the client backup data 110 may be performed by the server 104, the client device 102, or a third system. In many cases, having a scan performed by a system other than a known or suspected infected device may be able to detect malicious software that may disable, corrupt, or otherwise hinder operation of the client malicious software scanner 116.

A restore operation may involve restoring a single corrupt file, or restoring all or part of a file system. Some embodiments may have different actions available for a user to select, such as enabling a single file restore or an entire file system restore. Other embodiments may make a recommendation or take a course of action based on the type or severity of a malicious software infection. For example, when a malicious software attack is known to corrupt many different files, a full restore of an entire file system may be performed.

The backup application 112 may be any type of mechanism for backing up data from a client application. In some embodiments, a client application may push backup data to a server at periodic intervals. In other embodiments, a server may pull data from the client to create a backup. Some embodiment may use a file-based backup where files are archived individually and other embodiments may use a cluster-based backup system where blocks of data from a data storage system are archived without regard to a file structure.

The data storage device 108 attached to the server 104 may be any type of data storage system capable of archiving backup data. In some embodiments, the data storage device 108 may comprise hard disk drives or other types of read/write media including optical storage systems, solid state memory devices, or other data storage systems. Similarly, the data storage system 107 attached to the client 102 may be any type of data storage system that contains data a user may wish to archive.

The network 106 may be any communications path between the client 102 and the server 104. The network 106 may be a local area network (‘LAN’), a wide area network (‘WAN’), the Internet, a wireless network such as a cellular telephone network, or other network where multiple devices may communicate. The network 106 may also be a point to point communication path such as a serial or parallel communication channel established between the two devices. In some embodiments, the network 106 may comprise a wireless communication path.

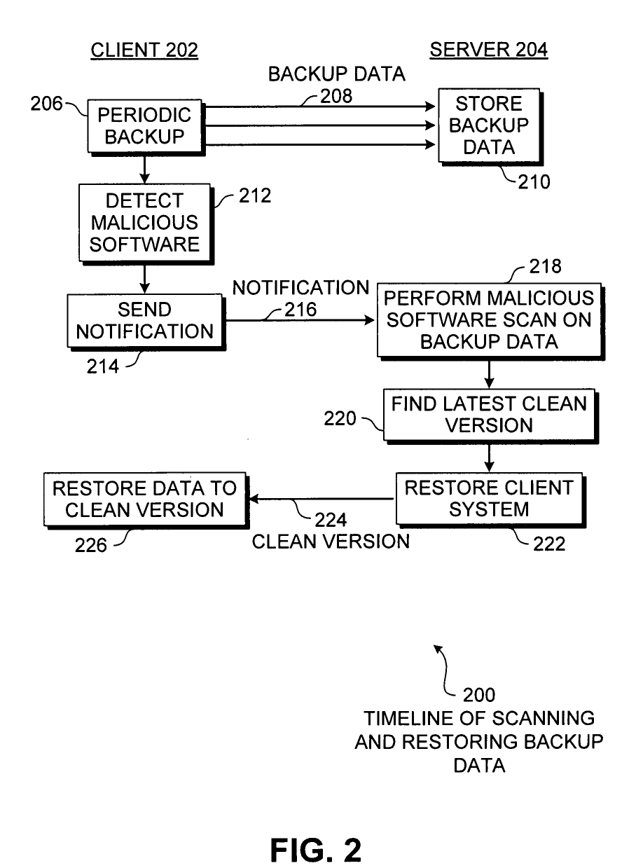

FIG. 2 is a timeline illustration of an embodiment 200 showing a sequence for scanning and restoring backup data. Actions performed by a client 202 are shown on the left while actions performed by a server 204 are shown on the right.

The client 202 performs a periodic backup in block 206 that sends backup data 208 to the server 204 that stores the backup data in block 210. This mechanism may be any type of backup system that archives data from the client 202. In some embodiments, the backup system may be a comprehensive backup system that archives an entire data storage system, volume, or other large, organized portion of data. In other embodiments, the backup system may archive specific files or other portions of a data contained in a data storage system.

Malicious software is detected in block 212. Malicious software may be detected by any device, including the server 204, the client 202, or a third device. Further, malicious software may be detected by any means, including scanning a data storage device attached to the client 202, scanning an executing application on a processor of the client 202, detecting abnormal output or unexpected function on the client 202, or any other mechanism.

When malicious software is detected in block 212, the client 202 may send, in block 214, a notification 216 to the server 204. The server 204 may perform a scan for malicious software on backup data in block 218 and find a latest clean version in block 220. In some instances, the scan of backup data of block 218 may be a comprehensive scan of all backup data. In other instances, archived versions of a particular file or set of files may be scanned.

After a latest clean version is detected in block 220, the clean version may be made available to restore the client system in block 222. During the restore process, a clean version 224 of data to be restored is sent from the server 204 to the client 202 so that the data may be restored to a clean version in block 226.

The timeline of embodiment 200 illustrates one sequence by which archived data may be scanned to determine a version of the data that is not infected with malicious software. An uninfected version of the data is then used to overwrite or restore infected data. In general, a restore may be performed with the latest version of a file or file system that is not infected with malicious software. In some embodiments, however, a restore may be performed with older versions based on predetermined situations or through user selection.

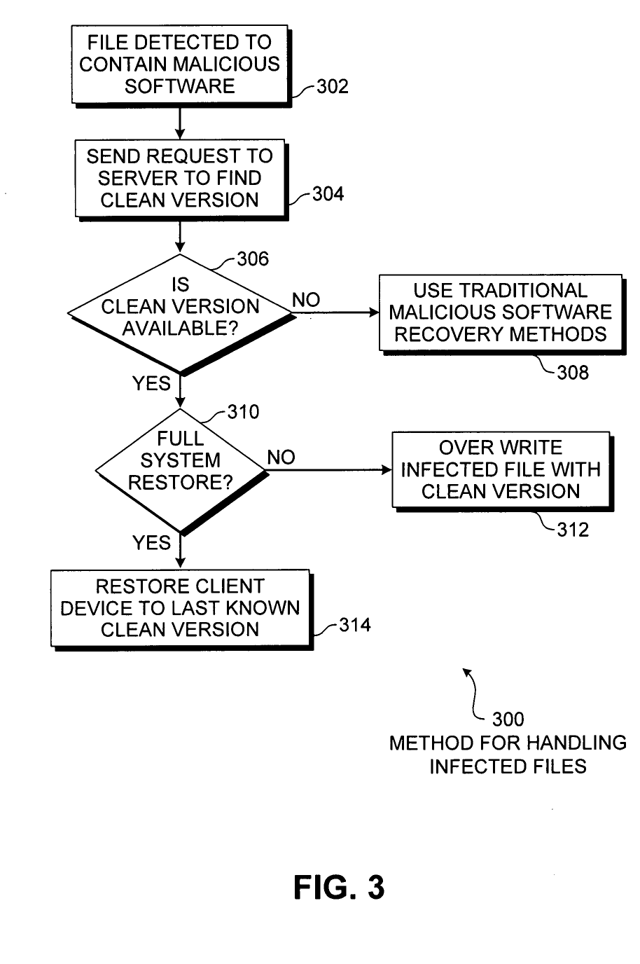

FIG. 3 is a flowchart illustration of an embodiment 300 showing a method for handling infected files, as may be performed by a client device. In block 302, a file is detected to contain malicious software. A request may be sent to a server to find a clean version of the file in block 304. If a clean version of the file is not available in block 306, traditional malicious software recovery methods may be used in block 308.

Traditional malicious software recovery methods may be any mechanism useful to correct or minimize any problems created by the detected malicious software. Such methods may include rebuilding the file, disabling the malicious software, removing the infected file, or any other mechanism.

If a clean version of the file or file system is found in block 306, a user or system may select to not perform a full system restore in block 310 and then overwrite infected file with a clean version in block 312 as a partial restore.

If a clean version of the file or file system is found in block 306 and a full system restore is selected in block 310, the client device is restored to a last known clean version in block 314.

Embodiment 300 is an illustration of a method that may be employed by a client device to handle the recovery of a file or file system in the event of an infection by malicious software. After detection, a request is made of a server to find a clean version of a specific file, a portion of a file system, or an entire file system. In the case of a cluster-based backup system, a server may be requested to find a clean version of an archive from a data storage device.

When a version of the file or file system is found that is clean of malicious software, the version may be made available to restore some or all of the file system on the client device.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
storing a plurality of successive backups of a file system;
scanning said plurality of successive backups for malicious software;
determining a latest version that does not contain an infected file, said file system being created by a first device, and said scanning being performed by a second device; and
restoring at least a portion of said latest version to said first device.

2. The method of claim 1, said successive backups being file-based backups.

3. The method of claim 1, said successive backups comprising at least one incremental backup.

4. The method of claim 1, said successive backups being cluster-based backups.

5. The method of claim 4, said scanning being performed on all clusters of said cluster-based backups.

6. The method of claim 1, said restoring comprising a complete restore using said latest version.

7. The method of claim 1, said restoring comprising restoring a clean version of said infected file.

8. A computer readable medium comprising computer executable instructions adapted to perform the method of claim 1.

9. A server comprising:
a network connection;
a data storage system adapted to store at least one backup of a client device;
a processor adapted to:
scan said at least one backup for malicious software;
determine an uninfected version of said at least one backup; and
restore at least a portion of said uninfected version of said backup to said client device.

10. The server of claim 9, said at least one backup being a file-based backup.

11. The server of claim 9, said at least one backup comprising an incremental backup.

12. The server of claim 9, said at least one backup being a cluster-based backup.

13. The server of claim 12, said scanning being performed on all clusters of said cluster-based backups.

14. A method comprising:
storing a plurality of backups of a file system onto a server computer, said file system being a file system attached to a client device;
initiating a scanning device to perform a scan of said plurality of backups for malicious software to determine a one of said plurality of backups that does not contain malicious software; and
restoring at least a portion of said file system on said client device using said one of said plurality of backups.

15. The method of claim 14, said backups being file-based backups.

16. The method of claim 14, said backups being cluster-based backups.

17. The method of claim 16, said scanning being performed on all clusters of said cluster-based backups.

18. The method of claim 16, said restoring comprising a complete restore using said one of said plurality of backups.

19. The method of claim 16, said restoring comprising restoring a clean version of an infected file.

20. A computer readable medium comprising computer executable instructions adapted to perform the method of claim 1.
